(19) United States
(12) Patent Application Publication
(10) Pub. No.: US 2015/0274951 A1
(43) Pub. Date: Oct. 1, 2015

(54) ARTICLES PREPARED FROM NANOFILLED IONOMER COMPOSITIONS

(71) Applicant: E.I. DU PONT DE NEMOURS AND COMPANY, Wilmington, DE (US)

(72) Inventors: Karlheinz Hausmann, Auvernier (CH); Sam Louis Samuels, Landenberg, PA (US); Gordon Mark Cohen, Wynnewwod, PA (US); Mark David Wetzel, Newark, DE (US)

(21) Appl. No.: 14/434,620

(22) PCT Filed: Oct. 11, 2013
(86) PCT No.: PCT/US2013/064438

§ 371 Date: Apr. 9, 2015

Related U.S. Application Data
(60) Provisional application No. 61/713,027, filed on Oct. 12, 2012.

(30) Foreign Application Priority Data
Oct. 10, 2013 (US) PCT/US2013/064207

(51) Int. Cl. C08L 23/26; B29C 49/02; B29C 45/00; B29C 43/02

(52) U.S. Cl. CPC C08L 23/26; B29C 43/02; B29C 49/02; B29C 45/0001; C08L 2205/025; B29K 2035/00

(57) ABSTRACT

A nanofilled ionomer composition comprises a nanofiller in a blend of a first ionomer and a second ionomer that is different from the first ionomer. The second ionomer is a water dispersable ionomer that allows for excellent dispersion of the nanofiller in the ionomer matrix. A variety of articles may comprise or be produced from the nanofilled ionomer composition, for example by injection molding.

This application claims priority from U.S. Provisional Patent Application Ser. No. 61/713,027, filed Oct. 12, 2012 and PCT Application Serial Number PCT/US13/64207, filed Oct. 10, 2013.

### FIELD OF THE INVENTION

The present invention relates to nanofilled ionomer compositions and to articles, for example injection molded articles, made from the ionomer compositions.

### BACKGROUND OF THE INVENTION

Several patents and publications are cited in this description in order to more fully describe the state of the art to which this invention pertains. The entire disclosure of each of these patents and publications is incorporated by reference herein.

Ionomers are copolymers produced by partially or fully neutralizing the carboxylic acid groups of precursor or parent polymers that are acid copolymers comprising copolymerized residues of α-olefins and α,β-ethylenically unsaturated carboxylic acids. Ionomers are thermoplastic polymers that possess many of the desirable characteristics for use in a number of applications. A variety of articles made from ionomers by injection molding processes have been used in our daily life.

For example, golf balls with ionomer covers have been produced by injection molding. See, e.g.; U.S. Pat. Nos. 4,714,253; 5,439,227; 5,452,898; 5,553,852; 5,752,889; 5,782,703; 5,782,707; 5,803,833; 5,807,192; 6,179,732; 6,699,027; 7,005,098; 7,128,864; 7,201,672; and U.S. Patent Application Publications 2006/0043632; 2006/0273485; and 2007/0282069.

Ionomers have also been used to produce injection molded hollow articles, such as containers. See, e.g. U.S. Pat. Nos. 4,857,258; 4,937,035; 4,944,906; 5,094,921; 5,788,890; 6,207,761; and 6,866,158, U.S. Patent Application Publications 20020180083; 20020175136; and 20050129888, European Patents EP1816147 and EP0855155, and PCT Patent Publications WO2004062881; WO2008010597; and WO2003045186.

Because ionomers are thermoplastic, the possibility of deformation, flow or creep of ionomers under high-temperature operating conditions has led to some limitations in use of ionomers in certain applications. Articles prepared from ionomers may have insufficient creep resistance for high temperature applications. A conventional method to increase stiffness and the heat deflection temperature (HDT) of thermoplastic materials has been to add glass fiber. Although increasing HDT, the addition of glass fiber increases weight, promotes poor surface appearance, molding difficulties and anisotropic properties such as shrinkage, and decreases toughness.

It is desirable to develop ionomer compositions with increased heat deflection temperature, increased stiffness/modulus at room temperature and elevated temperatures below the melting point of the ionomer, increased upper use temperature at a given stiffness and reduced long term creep at elevated temperatures.

Also, containers produced by injection molding often have thick wall structures. When ionomers are used in forming such injection molded containers, the optical properties may suffer due to the thickness of the wall. There is a need, especially in the cosmetics industry, to develop containers that are made of ionomer compositions and that have improved optical properties. Therefore it is desirable to provide ionomer compositions with improved heat distortion properties while retaining the improved optical properties of ionomers.

It is common in the plastics industry to blend various additives with a matrix polymer for the purpose of improving one or more polymer physical properties. In recent years, highly effective nanoparticle fillers have been developed and used as additives in polymer matrices in place of conventional mineral fillers. For example, U.S. Pat. No. 7,270,862 discloses combinations of nanofillers and polyolefins that impart improved barrier properties to polyamide compositions. Compositions that contain nanofillers dispersed in a polymer matrix are referred to as nanocomposites.

### SUMMARY OF THE INVENTION

Accordingly, provided herein are articles, such as injection-molded articles, comprising or produced from a nanofilled ionomer composition comprising or consisting essentially of

(1) a first ionomer that is an ionic, neutralized derivative of a precursor α-olefin carboxylic acid copolymer, wherein about 10% to about 35% of the total content of the carboxylic acid groups present in the precursor α-olefin carboxylic acid copolymer is neutralized to form salts containing alkali metal cations, alkaline earth metal cations, transition metal cations, or combinations of two or more of these metal cations, and wherein the precursor α-olefin carboxylic acid copolymer comprises (i) copolymerized units of an α-olefin having 2 to 10 carbons and (ii) about 15 to about 25 weight %, based on the total weight of the precursor α-olefin carboxylic acid copolymer, of copolymerized units of an α,β-ethylenically unsaturated carboxylic acid having 3 to 8 carbons, wherein the ionomer has a melt flow rate (MFR) of about 0.1 g/10 min to about 60 g/10 min;

(2) at least one nanofiller; and

(3) a second ionomer comprising a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min., wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising sodium cations, potassium cations or a combination thereof; and the second ionomer has a MFR from about 1 to about 20 g/10 min.; wherein MFR is measured according to ASTM D1238 at 190° C. with a 2.16 kg load.

The invention also provides a process for preparing an article described above comprising
(1) mixing the second ionomer with water heated to a temperature from about 80 to about 90° C. to provide a heated aqueous ionomer dispersion;
(2) optionally cooling the aqueous ionomer dispersion to ambient temperature;
(3) mixing the aqueous ionomer dispersion with the nanofiller to provide an aqueous dispersion of ionomer and nanofiller;
(4) removing the water from the aqueous dispersion of ionomer and nanofiller to provide a mixture of water dispersable ionomer and nanofiller in solid form;
(5) melt blending the mixture of water dispersable ionomer and nanofiller with the first ionomer to prepare a melt blend;
(6) processing the melt blend into a shape; and
(7) cooling the shaped melt blend.

The invention also provides a process for preparing an article described above comprising
(1) combining the second ionomer, water and the nanofiller in a high-shear melt-mixing process in a piece of equipment to form a melted mixture;
(2) continuing the high-shear melt-mixing until the nanoparticles are sufficiently comminuted or dispersed;
(3) optionally, removing some or all of the water from the melted mixture;
(4) optionally, repeating the addition and removal of water from the melted mixture;
(5) adding the ionomer to the melted mixture to form the nanofilled ionomer composition; and
(6) removing the nanofilled ionomer composition from the piece of equipment.

### DETAILED DESCRIPTION OF THE INVENTION

The following definitions apply to the terms as used throughout this specification, unless otherwise limited in specific instances.

The technical and scientific terms used herein have the meanings that are commonly understood by one of ordinary skill in the art to which this invention belongs. In case of conflict, the present specification, including the definitions herein, will control.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A ‘consisting essentially of’ claim occupies a middle ground between closed claims that are written in a ‘consisting of’ format and fully open claims that are drafted in a ‘comprising’ format. Optional additives as defined herein, at a level that is appropriate for such additives, and minor impurities are not excluded from a composition by the term “consisting essentially of”.

When a composition, a process, a structure, or a portion of a composition, a process, or a structure, is described herein using an open-ended term such as “comprising,” unless otherwise stated the description also includes an embodiment that “consists essentially of” or “consists of” the elements of the composition, the process, the structure, or the portion of the composition, the process, or the structure.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; that is, the phrase “A or B” means “A, B, or both A and B”. More specifically, a condition “A or B” is satisfied by any one of the following: A is true (or present) and B is false (or not present); A is false (or not present) and B is true (or present); or both A and B are true (or present). Exclusive “or” is designated herein by terms such as “either A or B” and “one of A or B”, for example.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. The scope of the invention is not limited to the specific values recited when defining a range.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

Unless stated otherwise, all percentages, parts, ratios, and like amounts, are defined by weight.

Unless otherwise specified under limited circumstances, all melt flow rates are measured according to ASTM method D1238 at a polymer melt temperature of 190° C. and under a weight of 2.16 kg. Moreover, the terms melt flow rate (MFR), melt flow index (MFI) and melt index (MI) are synonymous and used interchangeably herein.

In describing certain polymers it should be understood that sometimes applicants are referring to the polymers by the monomers used to produce them or the amounts of the monomers used to produce the polymers. While such a description may not include the specific nomenclature used to describe the final polymer or may not contain product-by-process terminology, any such reference to monomers and amounts should be interpreted to mean that the polymer comprises those monomers (i.e. copolymerized units of those monomers) or that amount of the monomers, and the corresponding polymers and compositions thereof.

In describing and/or claiming this invention, the term “copolymer” is used to refer to polymers formed by copolymerization of two or more monomers. Such copolymers include dipolymers, terpolymers or higher order copolymers.

The term “acid copolymer” as used herein refers to a polymer comprising copolymerized units of an α-olefin, an α,β-ethylenically unsaturated carboxylic acid, and optionally, other suitable comonomer(s) such as an α,β-ethylenically unsaturated carboxylic acid ester.

The term “ionomer” as used herein refers to a polymer that comprises ionic groups that are metal ion carboxylates, for example, alkali metal carboxylates, alkaline earth carboxylates, transition metal carboxylates and/or mixtures of such carboxylates. Such polymers are generally produced by partially or fully neutralizing the carboxylic acid groups of a precursor or “parent” polymer that is an acid copolymer, as defined herein, for example by reaction with a base. An example of an alkali metal ionomer as used herein is a sodium ionomer (or sodium neutralized ionomer), for example a copolymer of ethylene and methacrylic acid wherein all or a portion of the carboxylic acid groups of the copolymerized methacrylic acid units are in the form of sodium carboxylates.

As used herein, the term “nanofiller” refers to inorganic materials, including without limitation solid allotropes and oxides of carbon, having a particle size of about 0.9 to about 200 nm in at least one dimension. The related terms “nanofilled” and “nanocomposite” refer to a composition that contains nanofiller dispersed in a polymer matrix. In particular, a nanofilled ionomer composition contains a nanofiller dispersed in a polymer matrix comprising an ionomer as defined above.

The term “dispersed”, as used herein with respect to a nanofiller in a polymer matrix, refers to a state in which the nanofiller particles are sufficiently small in size and sufficiently surrounded by the polymer matrix so that the optical clarity of the nanocomposite is not significantly compromised. In particular, the nanofiller is dispersed when the haze of the nanocomposite is less than 5% or the difference in Transmitted Solar Energy (τₛₑ) between the polymer matrix and the nanocomposite is less than 0.5%.

In general, nanoclay particles are highly polar and prefer to associate with each other rather than a polymer that is of lower polarity, resulting in a poor dispersion. Surprisingly, the separated nanofiller particles that are dispersed in the ionomer as described herein do not re-agglomerate under melt processing conditions.

The invention provides articles comprising or prepared from a nanofilled ionomer composition. The addition of certain nanoparticles to thermoplastic polymers has been shown to significantly increase low shear viscosity and to reduce flow. It has been found that the addition of these nanoparticles to ionomers provides thermoplastic ionomer compositions that are “creep resistant” while maintaining transparency.

Articles comprising the nanofilled composition are described herein. The shaped article has a heat deflection temperature determined according to ASTM D-648 that exceeds that of a comparison standard article wherein the shaped article and the comparison standard article have the same shape and structure with the exception that the comparison standard article is prepared from an ionomer composition that does not comprise a nanofiller.

Measurement of the amount of movement (creep) of a test glass laminate after exposing the glass/thermoplastic interlayer/glass laminate to an elevated temperature for a specified amount of time can provide insights into relative creep performance of various materials in similar configurations, e.g. frameless glass-glass modules.

Laminates comprising ionomeric interlayers that were not modified by inclusion of nanofillers deformed significantly in creep measurement tests above 100° C., while laminates comprising nanofilled ionomer compositions as interlayers surprisingly showed little or no deformation after extended exposure to temperatures of 105° C. or 115° C.

The nanofilled ionomer compositions used herein contain ionomers that are ionic, neutralized derivatives of precursor acid copolymers. Examples of suitable ionomers are described in U.S. Pat. No. 7,763,360 and U.S. Patent Application Publication 2010/0112253, for example. Briefly, however, suitable precursor acid copolymers comprise copolymerized units of an α-olefin having 2 to 10 carbons and about 9 to about 30 weight % of copolymerized units of an α,β-ethylenically unsaturated carboxylic acid having 3 to 8 carbons, and 0 to about 40 weight % of other comonomers. The weight percentages are based on the total weight of the precursor acid copolymer. In addition, the amount of copolymerized α-olefin is complementary to the amount of copolymerized α,β-ethylenically unsaturated carboxylic acid and of other comonomer(s), if present, so that the sum of the weight percentages of the comonomers in the precursor acid copolymer is 100%.

Suitable α-olefin comonomers include, but are not limited to, ethylene, propylene, 1-butene, 1-pentene, 1-hexene, 1-heptene, 3 methyl-1-butene, 4-methyl-1-pentene, and the like and mixtures of two or more thereof. Preferably, the α-olefin is ethylene.

Suitable α,β-ethylenically unsaturated carboxylic acid comonomers include, but are not limited to, acrylic acids, methacrylic acids, itaconic acids, maleic acids, maleic anhydrides, fumaric acids, monomethyl maleic acids, and mixtures of two or more thereof. Preferably, the α,β-ethylenically unsaturated carboxylic acid is selected from acrylic acid, methacrylic acid, or mixtures thereof.

The precursor α-olefin carboxylic acid copolymer may comprise about 18 to about 25 weight %, preferably about 18 to about 23 weight %, such as about 18 to about 20 weight % or about 21 to about 23 weight %, of copolymerized units of the α,β-ethylenically unsaturated carboxylic acid and the precursor α-olefin carboxylic acid copolymer may have a melt flow rate of about 100 g/10 min or less, preferably about 30 g/10 min or less. Preferably, the α-olefin is ethylene. Preferably, the carboxylic acid is acrylic acid or methacrylic acid.

The precursor acid copolymers may further comprise copolymerized units of other comonomer(s), such as unsaturated carboxylic acids having 2 to 10, or preferably 3 to 8 carbons, or derivatives thereof. Suitable acid derivatives include acid anhydrides, amides, and esters. Esters are preferred. Specific examples of preferred esters of unsaturated carboxylic acids include but are not limited to those described in U.S. Patent Application Publication 2010/0112253. Examples of more preferred comonomers include, but are not limited to, alkyl (meth)acrylates such as methyl acrylate, methyl methacrylate, butyl acrylate, and butyl methacrylate; other (meth)acrylate esters, such as glycidyl methacrylates; vinyl acetates, and mixtures of two or more thereof. Alkyl acrylates are more preferred. The precursor acid copolymers may comprise 0 to about 40 weight % of other comonomers; such as about 5 to about 25 weight %. The presence of other comonomers is optional, however, and in some articles it is preferable that the precursor acid copolymer not include any other comonomer(s).

The α-olefin or the α,β-ethylenically unsaturated carboxylic acid of the acid copolymer precursor to the second ionomer may independently be the same as or different from the α-olefin or the α,β-ethylenically unsaturated carboxylic acid of the first precursor acid copolymer. Likewise, the amount of copolymerized units of the α-olefin or of the α,β-ethylenically unsaturated carboxylic acid of the second precursor acid copolymer may independently be the same as or different from the amount of copolymerized units of the α-olefin or of the α,β-ethylenically unsaturated carboxylic acid of the first precursor acid copolymer.

The precursor acid copolymers may be polymerized as disclosed in U.S. Pat. Nos. 3,404,134; 5,028,674; 6,500,888; 6,518,365; 7,763,360 and U.S. Patent Application Publication 2010/0112253. Preferably, the precursor acid copolymers are polymerized under process conditions such that short chain and long chain branching is maximized. Such processes are disclosed in, e.g., P. Ehrlich and G. A. Mortimer, “Fundamentals of Free-Radical Polymerization of Ethylene”, Adv. Polymer Sci., Vol. 7, p. 386-448 (1970) and J. C. Woodley and P. Ehrlich, “The Free Radical, High Pressure Polymerization of Ethylene II. The Evidence For Side Reactions from Polymer Structure and Number Average Molecular Weights”, J. Am. Chem. Soc., Vol. 85, p. 1580-1854. High levels of branching are associated with favorable properties such as reduced crystallinity, which leads to better clarity.

Unless indicated otherwise, melt flow rate (MFR) was determined in accordance with ASTM method D1238 at 190° C. and 2.16 kg. The precursor acid copolymer of the first ionomer may have a MFR of about 0.1 g/10 min or about 0.7 g/10 min to about 30 g/10 min, about 45 g/10 min, about 55 g/10 min, or about 60 g/10 min, or about 100 g/10 min. After neutralization, the MFR of the ionomer may be from about 0.1 to about 60 g/10 min., such as about 1.5 to about 30 g/10 min. The ionomer therefrom may have a melt flow rate of about 30 g/10 min or less, preferably about 5 g/10 min or less.

To obtain the first and second ionomers useful in the ionomer compositions described herein, the precursor acid copolymers are neutralized with a base so that the carboxylic acid groups in the precursor acid copolymer react to form carboxylate groups. Preferably, the precursor acid copolymers are neutralized to a level of about 10 to about 70%, such as from about 10 to about 35%, or about 50 to about 70%, based on the total carboxylic acid content of the precursor acid copolymers as calculated or as measured for the non-neutralized precursor acid copolymers.

Any stable cation and any combination of two or more stable cations are believed to be suitable as counterions to the carboxylate groups in the first and second ionomers. For example, divalent and monovalent cations, such as cations of alkali metals (such as sodium or potassium), alkaline earth metals (such as magnesium), and some transition metals (such as zinc), may be used.

To obtain (e.g. sodium or zinc neutralized) ionomers useful in the nanofilled ionomer compositions, the precursor acid copolymers of the first ionomer are neutralized with for example a sodium or zinc-containing base to provide an ionomer wherein at least a portion of the hydrogen atoms of carboxylic acid groups of the precursor acid copolymer are replaced by metal cations. Preferably, for the first ionomer about 10% to about 70%, or about 15% to about 30% of the hydrogen atoms of carboxylic acid groups of the precursor acid are replaced by metal cations. That is, the acid groups are neutralized to a level of about 10% to about 70%, based on the total carboxylic acid content of the precursor acid copolymers as calculated or measured for the non-neutralized precursor acid copolymers. Likewise the second ionomer may be neutralized to a level of 50 to 70% by using sodium and/or potassium-containing bases. The preferred neutralization ranges make it possible to obtain an article with the desirable end use properties that are novel characteristics of the nanofilled ionomer compositions described herein, such as low haze, high clarity, sufficient impact resistance and low creep, while still maintaining melt flow that is sufficiently high so that the ionomer can be processed or formed into articles. The precursor acid copolymers may be neutralized as disclosed, for example, in U.S. Pat. No. 3,404,134.

Of note are precursor acid copolymers having a melt flow rate (MFR) of about 30 g/10 min or less. After neutralization, the MFR of the first ionomer may be from about 0.1 to about 60 g/10 min., such as about 1.5 to about 25 g/10 min. After neutralization, the MFR can be less than 2.5 grams/10 min, and possibly less than 1.5 g/10 min. Suitable ionomers made by neutralizing these precursor acid copolymers with a sodium-containing base have a MFR of about 2 g/10 min or less. Also of note are precursor acid copolymers having a melt flow rate (MFR) of about 60 g/10 min or less, as determined in accordance with ASTM method D1238 at 190° C. and 2.16 kg. Suitable ionomers made by neutralizing these precursor acid copolymers with a zinc-containing base have a MFR of about 30 g/10 min or less, such as about 3 to about 27 g/10 min.

The ionomers may also preferably have a flexural modulus greater than about 40,000 psi (276 MPa), more preferably greater than about 50,000 psi (345 MPa), and most preferably greater than about 60,000 psi (414 MPa), as determined in accordance with ASTM method D638. Ionomers described above as the first ionomer do not readily disperse in water.

Some examples of suitable sodium ionomers useful as the first ionomer are also disclosed in U.S. Patent Application Publication 2006/0182983.

The second ionomer comprises a water dispersable ionomer comprising or consisting essentially of an ionomer derived from a parent acid copolymer that comprises copolymerized units of ethylene and about 18 to about 30 weight % of copolymerized units of acrylic acid or methacrylic acid, based on the total weight of the parent acid copolymer. The parent acid copolymer has a melt flow rate (MFR) from about 200 to about 1000 g/10 min, measured according to ASTM D1238 at 190° C. with a 2160 g load. About 50% to about 70% of the carboxylic acid groups of the parent acid copolymer, based on the total carboxylic acid content of the parent acid copolymer as calculated for the non-neutralized parent acid copolymer, are neutralized to form the water dispersible ionomer, which includes carboxylic acid salts comprising sodium cations, potassium cations or a combination of sodium cations and potassium cations. The resulting water dispersable ionomer has a MFR from about 1 to about 20 g/10 min.

As discussed further below, the water dispersable ionomer is useful in providing a nanofilled ionomer composition in which the nanofiller is well-dispersed in the ionomer matrix.

The neutralization levels of two ionomers in a blend will equilibrate over time to a shared neutralization level that is determined by the total number of acid and base equivalents in the ionomer blend. The second ionomer has a MFR, at the neutralization level of the ionomer blend that is different from the MFR of the first ionomer at the same neutralization level.

The nanofilled ionomer compositions further contain nanofiller. The nanofiller may be present at a level of about 3 to about 70 weight %, based on the total weight of the nanofilled ionomer composition, preferably from about 3 to about 20 weight %, more preferably from about 5 to about 12 weight %.

Suitable nanofillers are described in the patent application entitled “IONOMER COMPOSITE,” filed concurrently herewith (PCT Application Serial Number PCT/US13/64207, filed Oct. 10, 2013) and incorporated herein by reference. Briefly, however, the nanofillers or nanomaterials suitable for use as the second component of the nanofilled ionomer composition typically have a particle size of from about 0.9 to about 200 nm in at least one dimension, preferably from about 0.9 to about 100 nm. The shape and aspect ratio of the nanofiller may vary, including forms such as plates, rods, or spheres.

The average particle size of layered silicates can be measured, for example using optical microscopy, transmission electron spectroscopy (TEM), or atomic force microscopy (AFM).

Preferred nanofillers for creep resistance include rodlike, platy and layered nanofillers. The nanofillers may be naturally occurring or synthetic materials. In one embodiment, the nanofillers are selected from nano-sized silicas, nanoclays, and carbon nanofibers. Exemplary nano-sized silicas include, but are not limited to, fumed silica, colloidal silica, fused silica, and silicates. Exemplary nanoclays include, but are not limited to, smectite (e.g., aluminum silicate smectite), hectorite, fluorohectorite, montmorillonite (e.g., sodium montmorillonite, magnesium montmorillonite, and calcium montmorillonite), bentonite, beidelite, saponite, stevensite, sauconite, nontronite, and illite. Of note is sepiolite, which is rod-shaped and imparts favorable thermal and mechanical properties. The carbon nanofibers used here may be single-walled nanotubes (SWNT) or multi-walled nanotubes (MWNT). Suitable carbon nanofibers are commercially available, such as those produced by Applied Sciences, Inc. (Cedarville, Ohio) under the tradename Pyrograf™. Nanofillers may also be produced from hydromica or sericite.

As used herein, “aspect ratio” is the square root of the product of the lateral dimensions (area) of a platelet filler particle divided by the thickness of the platelet. Platelets with aspect ratio greater than 25, such as greater than 50, greater than 1,000 or greater than 5,000, are considered herein to have a “high aspect ratio”. Since there will be a distribution of different particles in a sampling of nanofiller, aspect ratio as used herein is based on the average of the primary exfoliated individual particles in the distribution. An exfoliated nanofiller may likely have residual tactoids that may be several primary platelets thick (e.g. 10-20 nanometers thick).

“Effective aspect ratio” relates to the behavior of the platelet filler in a binder. Platelets in a binder may not exist in a single platelet formation. If the platelets are not in a single layer in the binder, the aspect ratio of an entire bundle, aggregate or agglomerate of platelet fillers in a binder is less than that of the individual platelet. Additional discussion of these terms may be found in U.S. Pat. No. 6,232,389.

Nanofillers that are layered silicates or “phyllosilicates” are of particular note. Preferably, the layered silicates are obtained from micas or clays or from a combination of micas and clays. Preferred layered silicates include, without limitation, pyrophillite, talc, muscovite, phlogopite, lepidolithe, zinnwaldite, margarite, hydromuscovite, hydrophlogopite, sericite, montmorillonite, nontronite, hectorite, saponite, vermiculite, sudoite, pennine, klinochlor, kaolinite, dickite, nakrite, antigorite, halloysite, allophone, palygorskite, and synthetic clays such as Laponite™ and the like that are derived from hectorite, clays that are related to hectorite, or talc. More preferably, the layered silicates are obtained from hectorite, fluorohectorite, pyrophillite, muscovite, phlogopite, lepidolithe, zinnwaldite, hydromuscovite, hydrophlogopite, sericite, montmorillonite, vermiculite, kaolinite, dickite, nakrite, antigorite or halloysite. Still more preferably, the layered silicates are selected from the group consisting of materials based on or derived from hectorite, muscovite, phlogopite, pyrophillite and zinnwaldite, for example synthetic layered silicates, hydrous sodium lithium magnesium silicates, and hydrous sodium lithium magnesium fluorosilicates based on hectorite. Also of particular note are muscovite and synthetic clays that are based on muscovite. The nanofiller clays may optionally further comprise ionic fluorine, covalently bound fluorine, other cations aside from those in the natural clays, or sodium pyrophosphate.

More preferred layered silicates include synthetic hectorites such as Laponite™ synthetic layered silicate, available from Rockwood Additives (Southern Clay Products, Gonzales, Tex.). One such nanofiller, marketed under the tradename Laponite™ OG, is a Type 2 sodium magnesium silicate with a cation exchange capacity of about 60 meq/100 g and platelets about 83 nm long and 1 nm thick. More generally, preferred synthetic hectorites, such as Laponite™, have a particle size that is at least 50 nm in its largest dimension, or more preferably about 80 to about 100 nm. The average aspect ratio of the preferred synthetic hectorites is about 80 to about 100, although aspect ratios of about 300 may also be suitable. Clays, including synthetic hectorites, may be characterized by their cation exchange capacity. The preferred synthetic hectorites have a cation exchange capacity that is preferably less than 80 meq/100 g, more preferably less than 70 meq/100 g, and still more preferably less than 65 meq/100 g. Moreover, preferred synthetic hectorites have a low content of fluorine, preferably with less than 1 weight %, more preferably less than 0.1 weight %, and still more preferably less than 0.01 weight %, based on the total weight of the synthetic hectorite.

The surface of the layered silicates may be treated with surfactants or dispersants. Often, no such treatment is necessary or desirable. Preferably, when a surface treatment is used, the dispersant or surfactant does not comprise quaternary ammonium ions. These materials may degrade under processing conditions, lending an undesired color to the article. Tetrasodium pyrophosphate (TSPP) is a notable dispersant. When used as a surface treatment for layered silicates, the amount of the TSPP is 15 weight % or less, preferably 10 weight % or less, and more preferably 7 weight % or less, based on the total weight of the layered silicate.

Preferably, the nanofiller particles are comminuted, disintegrated or exfoliated to thin plate-like particles by suitable methods such as calcining or milling “Exfoliation” is the separation of individual layers of the platelet particles and the initial close-range order within the phyllosilicates is lost in this exfoliation process. The filler material used is at least partially exfoliated (at least some particles are separated into a single layer) and preferably is substantially exfoliated (the majority of the particles are separated into a single layer).

These processes produce smaller, thinner particles with higher aspect ratios. The smaller particles produce a clearer nanocomposite with increased enhancement of the desirable mechanical properties. The neat (“dry”) nanoparticles may be exfoliated, or the nanoparticles may be exfoliated in a suspension, such as a suspension in water, in another polar solvent, in oil, or in any combination of two or more suspension media. The comminution, disintegration, or exfoliation may be performed by any mechanical or thermal method, or by a combination of thermal and mechanical methods, for example using a stirrer, a sonicator, a homogenizer, or a rotor-stator. Preferably, the nanofiller is a layered silicate that is thoroughly exfoliated (i.e., de-layered or split) to form individual nanoparticles or small aggregates of a few nanoparticles in each.

In many embodiments, the layered silicates do not have any significant coloring tone. Also notable are layered silicates that do not have a coloring tone that is discernible to the naked eye and layered silicates that do not have a coloring tone that influences the color of the polymer matrix significantly. Preferably, the layered silicates are thoroughly comminuted, disintegrated or exfoliated from the form in which they are supplied.

For layered silicate nanofillers, the mean thickness of an individual platelet is about 1 nm and the mean length or width is in the range of about 25 nm to about 500 nm. For Laponite™, which is smaller and has a lower aspect ratio, the mean length or width is preferably from about 40 nm to about 200 nm, and more preferably from about 75 to about 110 nm. The clay particles preferably show an average aspect ratio in the range of from about 10 to about 8000, from about 30 to about 2000 or from about 50 to about 500, and more preferably the average aspect ratio is about 30 to about 150. It is preferred that the clays used in the composition be able to hydrate to form gels or sols. Transparent, colorless clays are preferred, as they minimize adverse effects on the performance of articles comprising the composition, including clarity and transparency.

The use of nanofilled ionomeric materials as described herein will enhance the upper end-use temperature of articles that include these materials because they have reduced creep at elevated temperatures. The end-use temperature of the modules may be enhanced by up to about 20° C. to about 70° C., or by a greater amount. Also advantageously, because the nanofilled ionomer compositions remain thermoplastic, the articles described herein have improved recyclability with respect to articles comprising materials that exhibit low creep because they have been crosslinked. Moreover, because of their small particle size, nanofillers will not significantly affect the optical properties of the articles.

For example, the nanofillers effectively reduce the melt flow of the ionomer composition, while still allowing production of thermoplastic films or sheets. In addition, articles comprising nanofilled ionomeric materials will be more fire resistant than articles having a conventional ionomeric material. The reason is that the nanofilled ionomeric polymers have a reduced tendency to flow out of laminated articles, which in turn, could reduce the available fuel in a fire situation.

Suitable methods for the synthesis of ionomer nanocomposites are described in detail in the abovementioned concurrently filed patent applications (PCT Application Serial Number PCT/US13/64207) and in U.S. Pat. No. 7,759,414. Briefly, however, in the field of nanocomposites, attaining a homogeneous composite, i.e., a high degree of nanoparticle dispersion within the polymer matrix, is essential for achieving target performance. It is known that certain neat nanoparticles may be added directly to a neat ionomer, then dispersed and deagglomerated, preferably using a high-shear melt mixing process. It is also known for a relatively high amount of nanofiller to be dispersed in a relatively small amount of polymer to form a “masterbatch” which is subsequently diluted with a polymer matrix that may be the same as or different from the polymer in the masterbatch.

A preferred concentrated nanofiller masterbatch composition comprises (a) a water dispersable ionomer (as described above) and (b) a nanofiller. An aqueous dispersion of the water dispersable ionomer can be prepared by mixing the solid ionomer under low shear conditions with water heated to a temperature of from about 80 to about 90° C. Additional information regarding suitable water dispersable ionomers and the preparation of suitable aqueous ionomer dispersions is disclosed in U.S. application Ser. No. 13/589,211. The aqueous ionomer dispersion can be mixed with the nanofiller, also under low shear conditions at about 80 to about 90° C., followed by evaporation of the water to provide a solid ionomer/nanofiller masterbatch.

The concentrated nanofiller masterbatch may comprise about 10 to about 95 weight %, about 20 to about 90 weight %, about 30 to about 90 weight %, about 40 to about 75 weight %, or about 50 to about 60 weight % of the water dispersable ionomer and about 5 to about 70 weight %, about 10 to about 70 weight %, about 20 to about 70 weight %, about 25 to about 60 weight %, or about 30 to about 50 weight % of the nanofiller, based on the total weight of the masterbatch composition.

One preferred method for preparing the concentrated nanofiller masterbatch is a solvent process comprising the steps of (a) dispersing nanofillers in a selected solvent such as water, optionally using a dispersant or surfactant; (b) dissolving a solid water dispersable ionomer in the same solvent system; (c) combining the solution and the dispersion; and (d) removing the solvent.

In another preferred process for preparing a concentrated nanofiller masterbatch, pellets or powder of a solid water dispersable ionomer and nanofiller powder are metered into the first feed port of an extruder. The solid mixture is conveyed to the extruder's melting zone, where the ionomer is melted by mechanical energy input from the rotating screws and heat transfer from the barrel, and where high stresses break down the nanofiller agglomerate particles. Liquid water (typically deionized) is pumped into the melted mixture, for example under pressure through an injection port in the extruder. The melted mixture is conveyed to a region of the extruder that is open to the atmosphere or under vacuum pressure, where some or all of the water evaporates or diffuses out of the mixture. This evaporation or diffusion step may optionally be repeated once or more. The resulting viscous polymer melt with well dispersed nanoparticles is removed from the extrudate; for example, it may be pumped by the screws and extruded through a shaping die. Should further processing under high-shear melt-mixing conditions be required to improve the dispersion quality, the extruded material may optionally be fed to the extruder and reprocessed, again optionally with water injection and removal.

The concentrated nanofiller masterbatch can be blended with the ionomer that forms the bulk of the polymeric matrix to produce the nanofilled ionomeric material. These nanocomposite compositions may be prepared using a melt process, which includes combining all the components of the nanofilled ionomeric composition, including the masterbatch, the bulk ionomer and additional optional additives, if any. These components are melt compounded at a temperature of about 130° C. to about 230° C., or about 170° C. to about 210° C., to form a uniform, homogeneous blend. The process may be carried out using stirrers, Banbury™ type mixers, Brabender PlastiCorder™ type mixers, Haake™ type mixers, extruders, or other suitable equipment.

Methods for recovering the homogeneous ionomeric nanocomposite produced by melt compounding will depend on the particular piece of melt compounding apparatus utilized and may be determined by those skilled in the art. For example, if the melt compounding step takes place in a mixer such as a Brabender PlastiCorder™ mixer, the homogeneous nanocomposite may be recovered from the mixer as a single mass. If the melt compounding step takes place in an extruder, the homogeneous nanocomposite will be recovered after it exits the extruder die in a form (sheet, filament, pellets, etc.) that is determined by the shape of the die and any post-extrusion processing (such as embossing, cutting, or calendaring, e.g.) that may be applied.

Accordingly, a suitable process for preparing the nanofilled ionomer composition comprises
(1) mixing a solid water dispersable ionomer composition comprising a water dispersible ionomer, as described above, with water heated to a temperature of from about 80 to about 90° C. to provide a heated aqueous ionomer dispersion;
(2) optionally cooling the aqueous ionomer dispersion;
(3) mixing the aqueous ionomer dispersion with one or more nanofillers to provide an aqueous dispersion of ionomer and nanofiller;
(4) removing the water from the aqueous dispersion of ionomer and nanofiller to provide a mixture of water dispersable ionomer and nanofiller in solid form;
(5) melt blending the mixture of water dispersable ionomer and nanofiller with another ionomer that is described above as suitable for use in the nanofilled ionomeric composition, specifically an ionomer that is an ionic, neutralized derivative of a precursor α-olefin carboxylic acid copolymer, wherein about 10% to about 70% of the total content of the carboxylic acid groups present in the precursor α-olefin carboxylic acid copolymer is neutralized to form salts containing alkali metal cations, alkaline earth metal cations, transition metal cations, or combinations of two or more of these metal cations, and wherein the precursor α-olefin carboxylic acid copolymer comprises (i) copolymerized units of an α-olefin having 2 to 10 carbons and (ii) about 9 to about 25 weight %, based on the total weight of the precursor α-olefin carboxylic acid copolymer, of copolymerized units of an α,β-ethylenically unsaturated carboxylic acid having 3 to 8 carbons, wherein the ionomer has a melt flow rate (MFR) of about 0.1 g/10 min to about 60 g/10 min, as determined in accordance with ASTM method D1238 at 190° C. and 2.16 kg load.

Another suitable process for preparing the nanofilled ionomer composition comprises forming a concentrated nanofiller masterbatch in an extruder using water and a solid water dispersable ionomer, as described above; optionally removing the concentrated nanofiller masterbatch from the equipment, cooling it and forming it into a convenient shape, such as pellets; and melt blending the concentrated nanofiller masterbatch with another ionomer that is described above as suitable for use in the nanofilled ionomeric composition, such as the ionomer described immediately above with respect to the aqueous dispersion process.

Accordingly, a preferred nanofilled ionomer composition for use in the articles comprises:

(1) an alkali metal ionomer that is an ionic, neutralized derivative of an ethylene carboxylic acid copolymer, wherein about 20% to about 70% of the total content of the carboxylic acid groups present in the precursor ethylene carboxylic acid copolymer are neutralized with alkali metal ions such as sodium, potassium or combinations thereof, and wherein the precursor ethylene carboxylic acid copolymer comprises (i) copolymerized units of ethylene and (ii) about 15 to about 23 weight %, based on the total weight of the ethylene carboxylic acid copolymer, of copolymerized units of an α,β-ethylenically unsaturated carboxylic acid having 3 to 8 carbons; having a melt flow rate (MFR) of about 5 g/10 min or less;

(2) nanofiller; and

(3) a second ionomer comprising a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min., wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising sodium cations, potassium cations or a combination thereof; and the second ionomer has a MFR from about 1 to about 20 g/10 min. measured according to ASTM D1238 at 190° C. with a 2.16 kg load.

Another preferred nanofilled ionomer composition for use in the articles comprises:

(1) an ionomer that is an ionic, neutralized derivative of an ethylene carboxylic acid copolymer, wherein about 20% to about 70%, such as about 10 to about 15%, of the total content of the carboxylic acid groups present in the precursor ethylene carboxylic acid copolymer are neutralized with zinc ions, and wherein the precursor ethylene carboxylic acid copolymer comprises (i) copolymerized units of ethylene and (ii) about 18 to about 20 weight %, based on the total weight of the ethylene carboxylic acid copolymer, of copolymerized units of an α,β-ethylenically unsaturated carboxylic acid having 3 to 8 carbons; having a melt flow rate (MFR) of about 30 g/10 min or less, such as about 3 to about 27 g/10 min;

(2) nanofiller; and

(3) a second ionomer comprising a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min., wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising sodium cations, potassium cations or a combination thereof; and the second ionomer has a MFR from about 1 to about 20 g/10 min. measured according to ASTM D1238 at 190° C. with a 2.16 kg load.

The extent of dispersion of the nanofiller in the polymer matrix can be measured by X-ray diffraction. For example, X-ray diffraction (XRD) is commonly used to determine the interlayer spacing (d-spacing) of silicate layers in silicate-containing nanocomposites. When X-rays are scattered from the silicate platelets, peaks of the scattered intensity are observed corresponding to the clay structure. Based on Bragg's law, the interlayer spacing, i.e., the distance between two adjacent clay platelets, can be determined from the peak position of the XRD pattern. When interaction of nanoclay and polymer matrix occurs, and the polymer is inserted between the layers of clay, the interlayer spacing increases, and the reflection peak of the XRD pattern moves to a lower 2-THETA position. Under such conditions, the nanoclay is considered to be intercalated.

The masterbatch and the nanofilled ionomer composition may also contain other additives known in the art. Such additives include, but are not limited to, plasticizers, processing aides, flow enhancing additives, flow reducing additives (e.g., organic peroxides), lubricants, pigments, dyes, optical brighteners, flame retardants, impact modifiers, nucleating agents, antiblocking agents (e.g., silica), thermal stabilizers, hindered amine light stabilizers (HALS), UV absorbers, UV stabilizers, dispersants, surfactants, chelating agents, coupling agents, adhesives, primers, and the like, and mixtures or combinations of two or more conventional additives. These additives are described in the Kirk Othmer Encyclopedia of Chemical Technology, 5^{th} Edition, John Wiley & Sons (New Jersey, 2004), for example.

These conventional ingredients may be present in the compositions in quantities that are generally from 0.01 to 15 weight %, preferably from 0.01 to 10 weight %, so long as they do not detract from the basic and novel characteristics of the composition and do not significantly adversely affect the performance of the composition or of the articles prepared from the composition. In this connection, the weight percentages of such additives are not included in the total weight percentages of the thermoplastic compositions defined herein. Typically, many such additives may be present in from 0.01 to 5 weight %, based on the total weight of the ionomer composition.

The optional incorporation of such conventional ingredients into the compositions can be carried out by any known process. This incorporation can be carried out, for example, by dry blending, by extruding a mixture of the various constituents, by a masterbatch technique, or the like. See, again, the Kirk-Othmer Encyclopedia. Three notable additives are thermal stabilizers, UV absorbers, and hindered amine light stabilizers. These additives are described in detail in U.S. Patent Application Publication 2010/00166992.

In addition, the haze level of a filled polymer blend is often higher than that of any of the polymer components in the blend. It is therefore expected that the nanofilled ionomer composition described herein will have a haze level that is higher than those of the first and second ionomers. Also surprisingly, however, the ionomer blend described herein has a haze level that is lower than that of the second ionomer. Moreover, the ionomer blend may exhibit a haze level that is lower than that of either the first or the second ionomer.

Returning now to the description of the article provided herein, this article may be in any shape or form, such as a film or sheet or a molded article.

The article may be a film or sheet, which may be prepared by any conventional process, such as, dipcoating, solution casting, lamination, melt extrusion, blown film, extrusion coating, tandem extrusion coating, or by any other procedures that are known to those of skill in the art. The films or sheets are preferably formed by melt extrusion, melt coextrusion, melt extrusion coating, blown film, or by a tandem melt extrusion coating process.

Alternatively, the articles comprising the nanofilled ionomer compositions described herein are molded articles, which may be prepared by any conventional molding process, such as, compression molding, injection molding, extrusion molding, blow molding, injection blow molding, injection stretch blow molding, extrusion blow molding and the like. Articles may also be formed by combinations of two or more of these processes, such as for example when a core formed by compression molding is overmolded by injection molding.

Information about these fabrication methods may be found in reference texts such as, for example, the Kirk Othmer Encyclopedia, the Modern Plastics Encyclopedia, McGraw-Hill (New York, 1995) or the Wiley Encyclopedia of Packaging Technology, 2d edition, A. L. Brody and K. S. Marsh, Eds., Wiley-Interscience (Hoboken, 1997).

The article comprising the nanofilled ionomer composition described herein may be an injection molded article having a minimum thickness (i.e, the thickness at the smallest dimension of the article) of at least about 1 mm. Preferably, the injection molded article may have a thickness of about 1 mm to 100 mm, or 2 mm to 100 mm, or 3 to about 100 mm, or about 3 to about 50 mm, or about 5 to about 35 mm.

The article may be an injection molded article in the form of a multi-layer structure (such as an over-molded article), wherein at least one layer of the multi-layer structure comprises or consists essentially of the ionomer composition described above and that layer has a minimum thickness of at least about 1 mm. Preferably, the at least one layer of the multi-layer article has a thickness of about 1 mm to 100 mm, or 2 mm to 100 mm, or 3 to about 100 mm, or about 3 to about 50 mm, or about 5 to about 35 mm.

The article may be an injection molded article in the form of a sheet, a container (e.g., a bottle or a bowl), a cap or stopper (e.g. for a container), a tray, a medical device or instrument (e.g., an automated or portable defibrillator unit), a handle, a knob, a push button, a decorative article, a panel, a console box, or a footwear component (e.g., a heel counter, a toe puff, or a sole).

The article may be an injection molded intermediate article for use in further shaping processes. For example, the article may be a pre-form or a parison suitable for use in a blow molding process to form a container (e.g., a cosmetic container). The injection molded intermediate article may be in the form of a multi-layer structure such as the one described above, and it may therefore produce a container having a multi-layer wall structure.

Injection molding is a well-known molding process. When the article described herein is in the form of an injection molded article, it may be produced by any suitable injection molding process. Suitable injection molding processes include, for example, co-injection molding and over-molding. These processes are sometimes also referred to as two-shot or multi-shot molding processes.

When the injection molded article is produced by an over-molding process, the ionomer composition may be used as the substrate material, the over-mold material or both. In certain articles, when an over-molding process is used, the ionomer composition described herein may be over-molded on a glass, plastic or metal container. Alternatively, the ionomer compositions may be over-molded on any other articles (such as household items, medical devices or instruments, electronic devices, automobile parts, architectural structures, sporting goods, etc.) to form a soft touch and/or protective overcoating. When the over-mold material comprises the ionomer composition described herein, the melt index of the composition is preferably from 0.75 up to about 35 g/10 min.

In fabrication processes that incorporate a form of blow molding, such as, for example, injection blow molding, injection stretch blow molding and extrusion blow molding, and in substrates or monolayer articles that comprise the ionomer composition, the ionomer composition preferably comprises an ionomer having zinc cations. When the overmolding material comprises the ionomer composition, however, the ionomer may comprise any suitable cation. Also preferably, the precursor acid copolymer preferably has a melt index of 200 to 500 g/10 min, as determined in accordance with ASTM D1238 at 190° C. and 2.16 kg. In addition, the ionomer preferably has a melt index of from about 0.1 to about 2.0 g/10 min or from about 0.1 to about 35 g/10 min. More specifically, when the substrate comprises the ionomer, the ionomer preferably has a melt index of about 0.5 to about 4 g/10 min. When the overmolding material comprises the ionomer, however, the ionomer preferably has a melt index of from 0.1 g/10 min or 0.75 g/10 min or 4.0 g/10 min or 5 g/10 min up to about 35 g/10 min.

The nanofilled ionomer composition may be molded at a melt temperature of about 120° C. to about 250° C., or about 130° C. to about 210° C. In general, slow to moderate fill rates with pressures of about 69 to about 110 MPa may be used. The mold temperatures may be in the range of about 5° C. to about 50° C., preferably 5° C. to 20° C., and more preferably 5° C. to 15° C. Based on the nanofilled ionomer composition and the process type that is to be used, one skilled in the art would be able to determine the proper molding conditions required to produce a particular type of article.

### EXAMPLES

The following Examples are intended to be illustrative of the invention, and are not intended in any way to limit the scope of the invention.

### Material and Methods

Ionomers: The ethylene/methacrylic acid dipolymers listed in Table 1 were neutralized to the indicated extent by treatment with NaOH, zinc oxide or KOH using standard procedures to form sodium, zinc or potassium-containing ionomers. Melt flow rates (MFR) were determined in accordance with ASTM D1238 at 190° C. with a 2.16 kg mass.

TABLE 1

| Precursor Copolymer | | Ionomer | | | |
|---|---|---|---|---|---|
| Methacrylic acid, | MFR g/ | | | Neutralization | MFR g/ |
| weight %* | 10 min | | Cation | Level % | 10 min |
| 21.7 | 23 | ION-1 | Na⁺ | 26 | 1.8 |
| 19 | 330 | ION-2 | K⁺ | 50 | 4.5 |
| 19 | | ION-3 | Zn⁺² | 11-12 | 25 |
| 15 | | ION-4 | Zn⁺² | 16 | 5.5 |
| 15 | | ION-5 | Zn⁺² | 60 | 0.7 |
| 19 | | ION-6 | Na⁺ | 37 | 2.6 |
| 11 | | ION-7 | Na⁺ | 37 | 10 |
| 11 | | ION-8 | Zn⁺² | 57 | 5.2 |
| 15 | | ION-9 | Zn⁺² | 53 | 5.0 |
| 15 | | ION-10 | Na⁺ | 51 | 4.5 |
| 19 | 400 | ION-11 | Na⁺ | 50 | 5.3 |
| 19 | 400 | ION-12 | Na⁺ | 60 | 1.5 |
| 19 | 250 | ION-13 | Na⁺ | 60 | 1.4 |

*remainder ethylene

ION-1 and ION-3 through ION-10 are ionomers that are not readily water dispersable. ION-2 and ION-11 through ION-13 are water dispersable ionomers.

ION-14: An ionomer prepared from a terpolymer of ethylene, 23.5 weight % of n-butyl acrylate and 9 weight % of methacrylic acid, neutralized with Mg⁺² to a level of 51%, with MFR of 1.1 g/10 min., which is not readily water dispersable.
Nanofiller NF-1: a Type 2 sodium magnesium silicate with a cation exchange capacity (CEC) of about 60 meq/100 g and platelets about 83 nm long and 1 nm thick, commercially available from Rockwood Additives (Southern Clay Products, Gonzales, Tex.) under the tradename Laponite™ OG.
Additive UVS-1: a UV-stabilizer commercially available from BASF under the tradename Tinuvin™ 328.

### General Sheeting Process for Preparing Extruded Interlayer Sheets

Pellets of ionomer were fed into a 25 mm diameter Killion extruder using the general temperature profile set forth in Table 2. The polymer throughput was controlled by adjusting the screw speed. The extruder fed a 150 mm slot die with a nominal gap of 2 to 5 mm. The cast sheet was fed onto a 200 mm diameter polished chrome chill roll held at a temperature of between 10° C. and 15° C. rotating at 1 to 2 rpm.

TABLE 2

| Extruder Zone | Temperature (° C.) |
|---|---|
| Feed | Ambient |
| Zone 1 | 100-170 |
| Zone 2 | 150-210 |
| Zone 3 | 170-230 |
| Adapter | 170-230 |
| Die | 170-230 |

### Comparative Example Interlayer Sheet C1

UVS-1 (0.12 weight % based on the amount of polymer) was added to ION-1 in a single screw extruder operating at about 230° C. The resulting mixture was cast into a sheet for subsequent lamination as detailed below. The sheet measured about 0.9 mm thick.

### General Procedure for Preparing Aqueous Dispersions

A round-bottom flask equipped with a mechanical stirrer, a heating mantle, and a temperature probe associated with a temperature controller for the heating mantle was charged with water. The water was stirred and the neat solid ionomer ION-2 was added to the water at room temperature. The aqueous ionomer mixture was stirred at room temperature for 5 minutes and then heated to 80° C. Next, the mixture was stirred for 20 min at 90° C. until the ionomer was fully incorporated into the water, as judged by the clarity of the mixture. The heating mantle and temperature controller were removed from the round-bottom flask, and the aqueous ionomer mixture was cooled to room temperature with continued stirring.

Nanofiller was added as a powder to the aqueous ionomer mixture. During the addition, the aqueous ionomer mixture was stirred rapidly so that the nanofiller was incorporated smoothly without forming dry lumps. Stirring was continued for approximately 30 min until the nanofiller was dispersed, again as judged by the clarity of the mixture.

The aqueous ionomer mixture, with or without dispersed nanofiller, was dried before further use. The round bottom flask was attached to a rotary evaporator to which a house vacuum of about 100 mmHg was applied. The flask was immersed in a water bath at 65° C. and rotated slowly while the temperature bath was gradually raised to a maximum of 85° C. The rotary evaporation under heat and vacuum were continued for one to two days. The solid product was removed from the round bottom flask and further dried for about 16 to 64 hours in an oven at 50° C. under house vacuum (about 120 to 250 mm Hg) with a slowly flowing nitrogen atmosphere.

### Ionomer A

An aqueous dispersion of ION-2 was prepared and dried according to the general aqueous dispersion procedure above, in quantities shown in Table 3. There was no filler in this material.

### Ionomer B

An aqueous dispersion of ION-2 was prepared, mixed with filler NF-1 and dried according to the general aqueous dispersion procedure above, in quantities shown in Table 3.

TABLE 3

| | Ionomer A | Ionomer B |
|---|---|---|
| Deionized water, g | 165.0 | 165.0 |
| ION-2, g | 49.05 | 11.55 |
| NF-1, g | 0 | 4.95 |
| Calculated weight % of NF-1 in dried solids | 0 | 30 |

### General Procedure for Preparing Ionomer Blends

A Brabender PlastiCorder™ Model PL2000 mixer (available from Brabender Instruments Inc. of South Hackensack, N.J.) with Type 6 mixing head and stainless roller blades was heated to 140° C. and mixed at the same temperature. A portion of a solid ionomer (15 g of Ionomer A or of Ionomer B) was melt-blended in the mixer with 30.0 g of ION-1. The materials were mixed at 140° C. for 20 minutes at 75 rpm under a nitrogen blanket delivered through the ram. The blend was removed from the mixer and allowed to cool to room temperature. The two blends are summarized in Table 4.

A blend comprising ION-3 and 10 weight % of nanofiller is prepared using a similar procedure by substituting ION-3 for ION-1, blended with Ionomer B.

TABLE 4

| | Comparative Example C2 | Example 1 |
|---|---|---|
| Ionomer A (g) | 15 | 0 |
| Ionomer B (g) | 0 | 15 |
| ION-1 (g) | 30 | 30 |
| Calculated weight % of NF-1 | 0 | 10 |

### Comparative Example C2

### Interlayer Sheet

Two films were formed by molding the blend of Comparative Example C2 (see Table 4) in a hydraulic press at 190° C., incrementally raising the pressure to 152 MPa, and holding the temperature and pressure for 210 seconds, followed by cooling the platens to around 37° C. and removing the resultant films from the mold. The cooled films measured about 0.8 mm thick.

### Example 1

### Interlayer Sheet

Two films were formed by molding the composition of Example 1 (see Table 4) in a hydraulic press at 215° C., incrementally raising the pressure to 152 MPa, and holding the temperature and pressure for 210 seconds, followed by cooling to around 37° C. and removing the resultant films from the mold. Cooled films measured about 0.8 mm thick.

### Glass Laminates

In order to assess the suitability of nanocomposites for creep resistance, glass laminates were prepared by the Lamination Process described below, using the films of Comparative Examples C1 and C2 and Example 1 to prepare two glass/interlayer/glass laminates from each of the three interlayer sheets.

Each glass/interlayer/glass laminate comprised a 102 mm×102 mm film of the interlayers described above, a 102 mm×204 mm×3 mm (rectangular) bottom glass plate and a 102 mm×102 mm×3 mm (square) top glass plate and were laminated as follows. The glass plates were high clarity, low iron Diamant® float glass from Saint Gobain Glass. Pre-laminates were laid-up with the interlayer film and the square glass plate coinciding and offset about 25 mm from one of the short edges of the rectangular glass plate. The “tin side” of each glass plate was in contact with the interlayer sheet. These specimens were laminated in a Meier vacuum laminator at 150° C. using a 5-minute evacuation, 1-minute press, 15-minute hold and 30-second pressure release cycle, using nominal “full” vacuum (0 mBar) and 800 mBar pressure.

### Creep Test

The glass laminates were tested for heat deformation or “creep.” Each laminate was hung from the top rack of an air oven by the 25-mm exposed edge of the larger glass plate using binder clips. The oven was preheated to 105° C. or to 115° C. The other end of the larger glass plate rested on a catch pan to prevent the laminate from slipping out of the binder clips. With this mounting system, the rectangular glass plate was constrained in a vertical position while the interlayer and square glass plate were unsupported and unconstrained. The vertical displacement of the smaller glass plates was measured periodically and reported in Table 5.

TABLE 5
Vertical Displacement in mm

| | | | |
|---|---|---|---|
| Time | Comparative | Comparative | |
| (hours) | Example C1 | Example C2 | Example 1 |

T = 105° C.

| | | | |
|---|---|---|---|
| 2.5 | 0 | 0 | 0 |
| 6 | 0 | 0 | 0 |
| 24 | 2 | 2 | 0 |
| 48 | 6 | 5 | 0 |
| 120 | 8 | 7 | 0 |
| 168 | 10 | 9 | 0 |
| 200 | 12 | 10 | 0 |

T = 115° C.

| | | | |
|---|---|---|---|
| 2.5 | 0 | 0 | 0 |
| 6 | 1 | 1 | 0 |
| 24 | 4 | 4 | 0 |
| 48 | 8 | 7 | 0 |
| 120 | 19 | 15 | 0 |
| 168 | 27 | 19 | 0 |
| 200 | 32 | 21 | 0 |

The results in Table 5 show that Comparative Examples C1 and C2 exhibited significant vertical displacement during the heat treatment. This vertical displacement is a measurement of creep. In contrast, the nanofilled composition (Example 1) exhibited no measurable vertical displacement throughout the duration of the tests. This result indicates that the nanofilled composition has very low creep or excellent creep resistance.

### Preparation of ION-2/NF-1 Masterbatch MB2 by Melt Extrusion

A ZSK-18 mm intermeshing, co-rotating twin-screw extruder (Coperion Corporation of Ramsey, N.J.) with 41 Length/Diameter (L/D) was used to make a an ION-2/NF-1 composite concentrate masterbatch using a melt extrusion process with water injection and removal. A conventional screw configuration was used containing a solid transport zone to convey pellets and clay powder from the first feed port, a melting section consisting of a combination of kneading blocks and several reverse pumping elements to create a seal to minimize water vapor escape, a melt conveying and liquid injection region, an intensive mixing section consisting of several combinations kneading block, gear mixer and reverse pumping elements to promote dispersion, distribution and polymer dissolution and water diffusion, one melt degassing and water removal zone and a melt pumping section. The melt was extruded through a die to form strands that were quenched in water at room temperature and cut into pellets. Polymer pellets and solid powders were metered into the extruder separately using loss in weight feeders (KTron Corp., Pitman, N.J.). Deionized (de-mineralized) water was injected into the extruder downstream of the melting zone using a positive displacement pump (Teledyne ISCO 500D, Lincoln, Nebr.). No attempt to exclude oxygen from the extruder was made. One vacuum vent zone was used to extract a portion of the water, volatile gases and entrapped air. Barrel temperatures, after the unheated feed barrel section, were set in a range from 160 to 185° C. depending on heat transfer and thermal requirements for melting, liquid injection, mixing, water removal and extrusion through the die. The throughput was fixed at 10 lb/hr and the screw rotational speed was 500 rpm. The deionized water injection flow rate was set to approximately 30 mL/minute. The extruded masterbatch pellets were then fed into the extruder for a second pass at a throughput of 10 lb/hr, a screw speed of 525 rpm, and a water injection flow rate of 16 ml/minute. A masterbatch with NF-1 silicate concentration of 25 weight % was produced. No organic surface modifiers were used on the NF-1 or added during the extrusion process.

### General Procedure for Preparing Ionomer Blends by Extrusion Melt Blending

A ZSK-18 mm intermeshing, co-rotating twin-screw extruder (Coperion Corp.) with 41 Length/Diameter (L/D) was used to melt and mix masterbatch MB2 described immediately above with ION-1 matrix polymer. A conventional screw configuration was used containing a solid transport zone to convey pellets from the first feed port, a melting section consisting of a combination of kneading blocks and one or more reverse pumping elements, a melt conveying region, a distributive mixing section consisting of several combinations of kneading block, gear mixer and reverse pumping elements, one melt degassing zone and a melt pumping section. Host (matrix) polymer and masterbatch pellets were metered into the extruder separately using two loss-in-weight feeders (KTron Corp.). No attempt to exclude oxygen from the extruder was made. For these samples, barrel temperatures were set in a range from 150 to 180° C. depending on heat transfer and thermal requirements for melting, mixing and extrusion through the die. The melt was then extruded through a die to form strands that were quenched in water at room temperature and cut into pellets. The throughput was fixed at 12 lb/hr and the screw rotational speed was 350 rpm. Extruded pellet samples were dried in conventional pellet drying equipment at 60 to 65° C. to reduce the moisture level below 1000 ppm. Pellet samples were packaged in metal lined, vacuum sealed bags. The compositions of the blends thus produced are summarized in Table 6.

Similar blends comprising ION-3 and 5 or 10 weight % of nanofiller are prepared using a similar procedure by substituting ION-3 for ION-1.

TABLE 6

| | Comparative Example C3 | Example 2 | Example 3 |
|---|---|---|---|
| ION-2 (weight %) | 30 | 15 | 30 |
| NF-1 (weight %) | 0 | 5 | 10 |
| ION-1 (weight %) | 70 | 80 | 60 |

Four films of each composition in Table 6 were prepared using the procedure described for Comparative Example C1 above. The films were used to prepare glass/interlayer/glass laminates according to the general procedure described above. After lamination the interlayer in each laminate was about 33 to 34 mils thick in a total laminate thickness of about 264 to 279 mils thick.

### Solar Energy Transmittance Testing

Transparency of the compositions was assessed using a solar energy transmittance test. The glass laminates were thoroughly cleaned using Windex® glass cleaner and lintless cloths to ensure that they were substantially free of dirt and other contaminants that might otherwise interfere with making valid optical measurements. The transmission spectrum of each laminate was then determined using a Varian Cary 5000 UV/VIS/NIR spectrophotometer (version 1.12) equipped with a DRA-2500 diffuse reflectance accessory, scanning from 2500 nm to 200 nm, with UV-VIS data interval of 1 nm and UV-VIS-NIR scan rate of 0.200 seconds/nm, utilizing full slit height and operating in double beam mode. The DRA-2500 is a 150 mm integrating sphere coated with Spectralon™. A total transmittance spectrum was obtained for each laminate and used to calculate Total Solar Energy Transmittance (τₛₑ) over the range of wavelengths from 1100 to 300 nm according to the method described in DIN EN 410. The results are summarized in Table 7. Solar energy transmittance is an indicator of the total solar energy that would be transmitted through the laminate to a photovoltaic cell.

TABLE 7

| Laminate | Solar Energy Transmittance (%) |
|---|---|
| Comparative Example C3 | 88.24 |
| Example 2 | 88.27 |
| Example 3 | 87.80 |

The data in Table 7 show that solar energy transmittance was not significantly affected by the inclusion of 5 to 10 weight % of nanofiller.

### Creep Test

The glass laminates were tested for creep performance according to the general procedure described above and the results as the average of eight measurements (four measurements of each laminate, two laminates of each interlayer) are summarized in Table 8.

TABLE 8
Vertical Displacement in mm

| | | | |
|---|---|---|---|
| Time | Comparative | | |
| (hours) | Example C3 | Example 2 | Example 3 |

T = 105° C.

| | | | |
|---|---|---|---|
| 2.5 | 0 | 0 | 0 |
| 8 | 1.7 | 0.4 | 0 |
| 24 | 4 | 1.7 | 0 |
| 48 | 8 | 2.7 | 0 |
| 120 | 18.6 | 4 | 0 |
| 144 | 23 | 4.4 | 0 |
| 200 | 33 | 5.6 | 0.2 |

T = 115° C.

| | | | |
|---|---|---|---|
| 2 | 0.7 | 0 | 0 |
| 6 | 2.3 | 0.6 | 0 |
| 24 | 9.5 | 2.5 | 0 |
| 48 | 20.4 | 4.1 | 0 |
| 120 | 58.9 | 8.0 | 0.7 |
| 168 | 76* | 9.9 | 0.8 |
| 200 | 76* | 10.9 | 0.9 |

*Maximum displacement possible in this test assembly

The results in Table 8 show that Comparative Example C3 exhibited significant creep during the thermal exposure. In contrast, the nanofilled compositions (Examples 2 and 3) exhibited superior creep resistance throughout the duration of the tests. Example 3, in which the ionomeric interlayer sheet contained 10 weight % of nanofiller, provided excellent creep resistance.

Heat deflection temperature (HDT) may be determined for the compositions at 264 psi (1.8 MPa) according to ASTM D648.

While certain of the preferred embodiments of this invention have been described and specifically exemplified above, it is not intended that the invention be limited to such embodiments. Various modifications may be made without departing from the scope and spirit of the invention, as set forth in the following claims.

What is claimed is:

1. An article comprising a nanofilled ionomer composition comprising
(1) a first ionomer that is an ionic, neutralized derivative of a precursor α-olefin carboxylic acid copolymer, wherein about 10% to about 35% of the total content of the carboxylic acid groups present in the precursor α-olefin carboxylic acid copolymer is neutralized to form salts containing alkali metal cations, alkaline earth metal cations, transition metal cations, or combinations of two or more of these metal cations, and wherein the precursor α-olefin carboxylic acid copolymer comprises (i) copolymerized units of an α-olefin having 2 to 10 carbons and (ii) about 15 to about 25 weight %, based on the total weight of the precursor α-olefin carboxylic acid copolymer, of copolymerized units of an α,β-ethylenically unsaturated carboxylic acid having 3 to 8 carbons, wherein the ionomer has a melt flow rate (MFR) of about 0.1 g/10 min to about 60 g/10 min;
(2) at least one nanofiller; and
(3) a second ionomer comprising a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min., wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising sodium cations, potassium cations or a combination thereof; and the second ionomer has a MFR from about 1 to about 20 g/10 min.; wherein MFR is measured according to ASTM D1238 at 190° C. with a 2.16 kg load.

2. The article of claim 1, wherein the precursor α-olefin carboxylic acid copolymer comprises about 18 to about 25 weight % of copolymerized units of the α,β-ethylenically unsaturated carboxylic acid and wherein the precursor α-olefin carboxylic acid copolymer has a melt flow rate of about 100 g/10 min or less and the ionomer has a melt flow rate of about 30 g/10 min or less, preferably about 5 g/10 min or less, preferably wherein the ionomer has a flexural modulus greater than about 40,000 psi (276 MPa), as determined in accordance with ASTM D638.

3. The article of claim 2 wherein the precursor α-olefin carboxylic acid copolymer comprises about 18 to about 23 weight % of copolymerized units of the α,β-ethylenically unsaturated carboxylic acid.

4. The article of claim 2 wherein the precursor α-olefin carboxylic acid copolymer has a melt flow rate of about 30 g/10 min or less and the ionomer has a melt flow rate of about 5 g/10 min or less.

5. The article of claim 2 wherein the ionomer has a flexural modulus greater than about 40,000 psi (276 MPa), as determined in accordance with ASTM D638.

6. The article of claim 1, wherein the nanofiller is present at a level of about 3 to about 70 weight % based on the total weight of the nanofilled ionomer composition and comprises a nano-sized silica, a nanoclay, or carbon nanofibers and has a particle size of about 0.9 to about 200 nm.

7. The article of claim 6 wherein the nano-sized silica comprises fumed silica, colloidal silica, fused silica, silicate, or mixtures of two or more thereof.

8. The article of claim 6 wherein the nanoclay comprises smectite, hectorite, fluorohectorite, montmorillonite, bentonite, beidelite, saponite, stevensite, sauconite, nontronite, illite, synthetic nanoclay, modified nanoclay, or mixtures of two or more thereof.

9. The article of claim 6 wherein the average aspect ratio of the nanofiller is about 30 to about 150.

10. The article of claim 6 wherein the nanofiller is a synthetic hectorite that is a Type 2 sodium magnesium silicate having a cation exchange capacity of about 60 meq/100 g, a platelet form, and a particle size of at least 50 nm in its largest dimension and about 1 nm thick.

11. The article of claim 1 that is in the form of a film or a sheet or a molded article.

12. The article of claim 1 that is a film or sheet prepared by a process comprising dipcoating, solution casting, lamination, melt extrusion, blown film, extrusion coating, or tandem extrusion coating.

13. The article of claim 11, having a minimum thickness of at least about 3 mm.

14. The article of claim 1 that is a molded article prepared by a process comprising compression molding, injection molding, extrusion molding, blow molding, injection stretch blow molding or extrusion blow molding.

15. The article of claim 14, which is an injection molded article.

16. The article of claim 11 wherein the article has a multilayer structure having at least one layer comprising the composition recited in claim 1, said at least one layer having a minimum thickness of at least about 3 mm.

17. The article of claim 16, which is produced by a process comprising co-injection molding; over-molding; co-injection blow molding; co-injection stretch blow molding or co-extrusion blow molding.

18. The article of claim 11 that is a sheet, container, cap or stopper, tray, medical device or instrument, handle, knob, push button, decorative article, panel, console box, or footwear component.

19. A process for preparing an article of claim 1 comprising
(1) mixing the second ionomer with water heated to a temperature from about 80 to about 90° C. to provide a heated aqueous ionomer dispersion;
(2) optionally cooling the aqueous ionomer dispersion to ambient temperature;
(3) mixing the aqueous ionomer dispersion with the nanofiller to provide an aqueous dispersion of ionomer and nanofiller;
(4) removing the water from the aqueous dispersion of ionomer and nanofiller to provide a mixture of water dispersable ionomer and nanofiller in solid form;
(5) melt blending the mixture of water dispersable ionomer and nanofiller with the first ionomer to prepare a melt blend;
(6) processing the melt blend into a shape; and
(7) cooling the shaped melt blend.

20. A process for preparing an article of claim 1 comprising
(1) combining the second ionomer, water and the nanofiller in a high-shear melt-mixing process in a piece of equipment to form a melted mixture;
(2) continuing the high-shear melt-mixing until the nanoparticles are sufficiently comminuted or dispersed;
(3) optionally, removing some or all of the water from the melted mixture;
(4) optionally, repeating the addition and removal of water from the melted mixture;
(5) adding the ionomer to the melted mixture to form the nanofilled ionomer composition; and
(6) removing the nanofilled ionomer composition from the piece of equipment.

21. The process of claim 19 wherein processing the melt blend into a desired shape comprises compression molding, injection molding, extrusion molding, blow molding, injection stretch blow molding or extrusion blow molding, co-injection molding; over-molding; co-injection blow molding; co-injection stretch blow molding or co-extrusion blow molding.

22. The process of claim 19 wherein processing the melt blend into a desired shape comprises dipcoating, solution casting, lamination, melt extrusion, blown film, extrusion coating, or tandem extrusion coating.

23. The process of claim 20 further comprising forming it into a convenient shape by compression molding, injection molding, extrusion molding, blow molding, injection stretch blow molding or extrusion blow molding, co-injection molding; over-molding; co-injection blow molding; co-injection stretch blow molding or co-extrusion blow molding.

24. The process of claim 20 further comprising forming it into a convenient shape by dipcoating, solution casting, lamination, melt extrusion, blown film, extrusion coating, or tandem extrusion coating.
